(19) United States
(12) Patent Application Publication
(10) Pub. No.: US 2022/0109654 A1
(43) Pub. Date: Apr. 7, 2022

(54) Method and System For Sharing Meta-Learning Method(s) Among Multiple Private Data Sets

(71) Applicant: Cognizant Technology Solutions U.S. Corporation, College Station, TX (US)

(72) Inventors: Daniel E. Fink, Berkeley, CA (US); Jason Liang, Fremont, CA (US); Risto Miikkulainen, Stanford, CA (US)

(73) Assignee: Cognizant Technology Solutions U.S. Corporation, College Station, TX (US)

(21) Appl. No.: 17/064,706

(22) Filed: Oct. 7, 2020

(51) Int. Cl. H04L 29/06; G06N 20/00

(52) U.S. Cl. CPC H04L 63/02; G06N 20/00

(57) ABSTRACT

Systems and processes for facilitating the sharing of models trained on a data set confined within a given firewall, i.e., a hidden data set, along with the model's performance metrics are described. The trained models may be used in further processes to improve the trained models to solve a predetermined problem or make a prediction.

### CROSS-REFERENCE TO RELATED APPLICATIONS

The present application incorporates by reference in their entireties the following commonly owned applications relating to neural architecture search: U.S. application Ser. No. 15/794,905, titled “EVOLUTION OF DEEP NEURAL NETWORK STRUCTURES,” filed on Oct. 26, 2017; U.S. application Ser. No. 15/794,913, titled “COOPERATIVE EVOLUTION OF DEEP NEURAL NETWORK STRUCTURES,” filed on Oct. 26, 2017; U.S. application Ser. No. 15/915,028, titled “ASYNCHRONOUS EVALUATION STRATEGY FOR EVOLUTION OF DEEP NEURAL NETWORKS”, filed on Mar. 7, 2018; U.S. application Ser. No. 15/912,475, titled “BEHAVIOR DOMINATED SEARCH IN EVOLUTIONARY SEARCH SYSTEMS,” filed on Mar. 5, 2018, now U.S. Pat. No. 10,744,372; U.S. application Ser. No. 16/934,681, titled “BEHAVIOR DOMINATED SEARCH IN EVOLUTIONARY SEARCH SYSTEMS,” filed on Jul. 21, 2020; U.S. application Ser. No. 16/172,660, titled “BEYOND SHARED HIERARCHIES: DEEP MULTITASK LEARNING THROUGH SOFT LAYER ORDERING,” filed on Oct. 26, 2018; U.S. application Ser. No. 16/219,286, titled “EVOLUTION OF ARCHITECTURES FOR MULTITASK NEURAL NETWORKS,” filed on Dec. 13, 2018; U.S. application Ser. No. 16/212,930, titled “EVOLUTIONARY ARCHITECTURES FOR EVOLUTION OF DEEP NEURAL NETWORKS,” filed Dec. 7, 2018; U.S. application Ser. No. 16/213,118, titled “EVOLVING RECURRENT NETWORKS USING GENETIC PROGRAMMING,” filed Dec. 7, 2018; U.S. application Ser. No. 16/270,681, titled “SYSTEM AND METHOD FOR PSEUDO-TASK AUGMENTATION IN DEEP MULTITASK LEARNING,” filed Feb. 8, 2019; U.S. application Ser. No. 16/671,274, titled “MULTIOBJECTIVE COEVOLUTION OF DEEP NEURAL NETWORK ARCHITECTURES, filed Nov. 1, 2019; and U.S. application Ser. No. 16/817,153, titled “SYSTEM AND METHOD FOR IMPLEMENTING MODULAR UNIVERSAL REPARAMETERIZATION FOR DEEP MULTI-TASK LEARNING ACROSS DIVERSE DOMAINS,” filed Mar. 12, 2020.

In addition to the above, the present application incorporates by reference in their entireties the following commonly owned applications relating to loss-function optimization: U.S. application Ser. No. 16/878,843, titled “SYSTEM AND METHOD FOR LOSS FUNCTION METALEARNING FOR FASTER, MORE ACCURATE TRAINING, AND SMALLER DATASETS,” filed May 20, 2020; U.S. Provisional Application Ser. No. 62/902,458, titled “LOSS FUNCTION OPTIMIZATION USING TAYLOR SERIES EXPANSION,” filed Sep. 19, 2019; and U.S. Provisional Application Ser. No. 62/902,464, titled “GENERATIVE ADVERSARIAL NETWORK OPTIMIZATION,” filed Sep. 19, 2019.

In addition to the above, the present application incorporates by reference in its entirety the following commonly owned application relating to data augmentation: U.S. Provisional Application Ser. No. 62/987,138, titled “SYSTEM AND METHOD FOR EVOLVED DATA AUGMENTATION AND SELECTION,” filed Mar. 9, 2020.

In addition to the above, the present application incorporates by reference in its entirety the following commonly owned application relating to evolving activation functions: U.S. Provisional Application Ser. No. 63/064,483, titled “SYSTEM AND METHOD FOR GENERATING PARAMETRIC ACTIVATION FUNCTIONS,” filed Aug. 12, 2020.

In addition to the above, the present application incorporates by reference in their entireties the following commonly owned applications relating to involving secure evolution as a service and abstractions: U.S. application Ser. No. 16/424,686, titled “SYSTEMS AND METHODS FOR PROVIDING SECURE EVOLUTION AS A SERVICE, filed May 29, 2019; and U.S. application Ser. No. 16/502,439, titled “SYSTEMS AND METHODS FOR PROVIDING DATA-DRIVEN EVOLUTION OF ARBITRARY DATA STRUCTURES, filed Jul. 3, 2019.

Further, one skilled in the art appreciates the scope of the existing art which is assumed to be part of the present disclosure for purposes of supporting various concepts underlying the embodiments described herein. By way of particular example only, prior publications, including academic papers, patents and published patent applications listing one or more of the inventors herein are considered to be within the skill of the art and constitute supporting documentation for the embodiments described herein.

### FIELD OF THE TECHNOLOGY

The technology disclosed relates generally to sharing information learned by complex models on private data without exposing the private data.

### BACKGROUND

Developing high performing deep learning models is contingent upon higher amounts of data since results get better and more generalized with more data and larger models. And high performing deep learning models are able to make better predictions and solve more problems. But not all data sets are publicly available. In fact, many data sets are proprietary. So, how do we find better models (e.g., deep learning) for multiple data sets when each of the individual data sets themselves are owned (controlled) by different parties and the data sets are kept behind their own separate firewalls. Data sets may be kept behind firewalls are for privacy reasons (e.g., multiple healthcare data sets that cannot leave the site of multiple hospital/insurance providers), for proprietary reasons (competitive business-related data such as advertising data) or both. As such, it would be expected that a model trained on the hidden data sets would also be proprietary, i.e., hidden. This inability to access hidden data and/or models trained on hidden data stifles model development and model improvement and limits generalization.

Further, the usefulness of deep learning models as teachers in the teacher/student frameworks is also hindered by data privacy concerns. Teacher/student frameworks have been developed in an effort to address issues including size and resources, e.g., processing requirements, wherein smaller, more compact networks may be trained to provide results with similar (or even better) performance to the larger and more complex teachers networks. Smaller models could then be implemented in smaller processing devices such as mobile and portable devices. This process of knowledge transfer from teacher to student is also referred to in some applications as knowledge distillation (KD). The following article summarize KD and the student-teacher learning frameworks in the prior art: Abbasi et al., Modeling Teacher-Student Techniques in Deep Neural Networks for Knowledge Distillation, available online at arxiv.org/ftp/arxiv/papers/1912/1912.13179 (Dec. 31, 2019) and Wang et al, Knowledge Distillation and Student-Teacher Learning for Visual Intelligence: A Review and New Outlooks, Journal of Latex Class Files, Vol. 15, No. 8, April 2020, which are incorporated herein by reference in their entireties. But initial teacher/student frameworks rely, to a large extent, on having access to at least some teacher training data; thus raising privacy concerns.

Some proposed prior art solutions to this problem suggest teacher/student frameworks which use no original data sets. See for example Nayak et al., Zero-Shot Knowledge Distillation in Deep Networks, Proceedings of the 36th International Conference on Machine Learning, Long Beach, Calif., PMLR 97, 2019 and Lopes et al, Data-Free Knowledge Distillation for Deep Neural Networks, 31st Conference on Neural Information Processing Systems (NIPS 2017), which are incorporated herein by reference. These solutions either attempt to reconstruct the original training data using metadata saved with the model (Lopes) or use no data, original or reconstructed (Nayak), to train the student model.

In the recent article to Gao et al., Private Knowledge Transfer via Model Distillation with Generative Adversarial Networks, published in proceedings of the 24^{th} European Conference on Artificial Intelligence—ECAI 2020, which is incorporated herein by reference, the authors acknowledge the privacy problem which exists with teacher/student frameworks and summarize various prior art solutions, including solutions which rely on differential privacy (DP) techniques and the use of KD techniques.

Accordingly, there is a need in the art for a process and system whereby models generated/trained using hidden data may be accessible for further use and development without the need to share the hidden data, such as in teacher/student KD frameworks.

### SUMMARY OF EMBODIMENTS

In a first exemplary embodiment, a process for providing access to one or more models for use in solving a predetermined problem or making a prediction, the one or more models being trained on private data, the process includes: evolving a teacher model in accordance with one or more domain factors, the evolving including: (i) creating by a first subsystem, including a first server, a first population of candidate teacher models and assigning a unique candidate identifier to each of the candidate teacher models in the first population; (ii) transmitting the first population of candidate teacher models with assigned candidate identifiers, to a second subsystem, including a second server, wherein the first server and the second server are separated by a first firewall; (iii) training by the second subsystem the first population of candidate teacher models against a first secure data set located behind the first firewall; (iv) determining by the second subsystem a set of performance metrics for each of the candidate teacher models, wherein the set of performance metrics does not include secure data from the first secure data set; (v) providing the set of performance metrics for each of the candidate teacher models in accordance with assigned candidate identifier to the first subsystem; (vi) creating a next population of candidate teacher models from the sets of performance metrics for each of the candidate teacher models from the second subsystem; (vii) repeating steps (ii) to (vi) until a best candidate teacher model is determined in accordance with a predetermined condition; and providing access to the best candidate teacher model in a commonly accessible location, wherein the best candidate teacher model operates on one or more additional datasets to train one or more best candidate student models to solve the predetermined problem or make the prediction.

In a second exemplary embodiment, a process for providing access to one or more models for use in solving a predetermined problem or making a prediction, the one or more models being trained on private data, the process includes: creating and training a teacher model by a first system including a first server, wherein the teacher model is trained on a first secure data set; determining by the first system a set of performance metrics for each of the teacher model, wherein the set of performance metrics does not include secure data from the first secure data set; providing access to the trained teacher model in a commonly accessible area, wherein the first subsystem and the commonly accessible area are separated by a first firewall; evolving a student model in accordance with one or more domain factors, the evolving including: (i) creating by a second subsystem, including a second server, a first population of candidate student models and assigning a unique candidate identifier to each of the candidate student models in the first population; (ii) transmitting the first population of candidate student models with assigned candidate identifiers, to a third subsystem, including a third server, wherein the second server and the third server are separated by a second firewall; (iii) training by the third subsystem the first population of candidate student models against a second secure data set located behind the second firewall; (iv) determining by the third subsystem a set of performance metrics for each of the candidate student models, wherein the set of performance metrics does not include secure data from the second secure data set; (v) providing the set of performance metrics for each of the candidate student models in accordance with assigned candidate identifier to the second subsystem; (vi) creating a next population of candidate student models from the sets of performance metrics for each of the candidate student models from the third subsystem; (vii) repeating steps (ii) to (vi) until a best candidate student model is determined in accordance with a predetermined condition; providing access to the best candidate student model in the commonly accessible area, wherein the second subsystem and the commonly accessible area are separated by a third firewall; and training the best candidate student model in accordance with operation by the trained teacher model on one or more additional datasets to solve the predetermined problem or make the prediction.

In a third exemplary embodiment, a process for providing access to one or more models for use in solving a predetermined problem or making a prediction, the one or more models being trained on private data, the process includes: evolving a teacher model in accordance with one or more domain factors, the evolving including: (i) creating by a first subsystem, including a first server, a first population of candidate teacher models and assigning a unique candidate identifier to each of the candidate teacher models in the first population; (ii) transmitting the first population of candidate teacher models with assigned candidate identifiers, via a candidate evaluation aggregator of the first subsystem, to multiple individual subsystems, including multiple individual servers, wherein the candidate evaluation aggregator and each of the multiple individual subsystems are separated by multiple individual firewalls; (iii) training by each of the multiple individual subsystems the first population of candidate teacher models against multiple individual first secure data sets located behind each of the multiple individual firewalls; (iv) determining by each of the multiple individual subsystems a set of performance metrics for each of the candidate teacher models, wherein the sets of performance metrics do not include secure data from and of multiple individual first secure data sets; (v) providing the sets of performance metrics for each of the candidate teacher models in accordance with assigned candidate identifier to the candidate evaluation aggregator; (vi) creating a next population of candidate teacher models from the sets of performance metrics for each of the candidate teacher models from each of the multiple individual subsystems; (vii) repeating steps (ii) to (vi) until a best candidate teacher model is determined in accordance with a predetermined condition; and providing access to the best candidate teacher model in a commonly accessible location, wherein the best candidate teacher model operates on one or more additional datasets to train one or more best candidate student models to solve the predetermined problem or make the prediction.

### BRIEF SUMMARY OF FIGURES

The embodiments will be described below and reference will be made to the figures, in which:

FIG. 1 is a teacher/student knowledge distillation schematic in accordance with one or more embodiments herein;

FIGS. 2(a)-2(b) exemplify a system and process for teacher model generation and evaluation on private data for use in a teacher/student knowledge distillation framework in accordance with an embodiment herein;

FIG. 3(a)-3(b) exemplify a system and process for student model generation and evaluation on private data for use in a teacher/student knowledge distillation framework in accordance with an embodiment herein;

FIG. 4 exemplifies a system and process for student and teacher model generation and evaluation on private data for use in a teacher/student knowledge distillation framework in accordance with an embodiment herein; and

FIG. 5 exemplifies a system and process for teacher model generation and evaluation on multiple private data sets for use in a teacher/student knowledge distillation framework in accordance with an embodiment herein.

### DETAILED DESCRIPTION

The embodiments described herein facilitate sharing of a model trained on a data set confined within a given firewall, i.e., hidden data set, along with the model's performance metrics.

Initially, a prior art technique of Teacher/Student Knowledge Distillation provides a useful starting point for the systems and processes described in the exemplary embodiments herein. For a generalize description of technical aspects of an exemplary teacher/student KD framework, see US Patent Application No. 2015/0356461 entitled Training Distilled Machine Learning Models which is incorporated herein by reference in its entirety. As discussed in the Background, there are privacy concerns related to the use of the original teacher training data set to train the student.

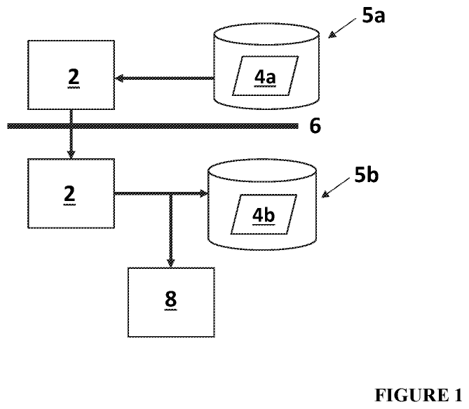

Referring to FIG. 1, a basic Teacher/Student network KD approach which protects training data would include training a single statistical model 2 (hereafter teacher network model) on a private (sequestered or hidden) data set 4a within the firewall 6 of each data source 5a. Training is generally done against a single hand-designed neural network architecture. The weights (learnings) of the trained teacher neural network, but not the data set itself, then need to be extracted from each firewalled area to a common location to be used in training a different neural network, i.e., a student neural network model 8, by minimizing the loss in a comparison between the Teacher network(s) and Student network model when manufactured (common) input data 4b is thrown at each model. That is, the Student network model learns from how the teacher network model reacts to the manufactured input data 4b from common (non-firewalled or separately firewalled) data source 5b.

The embodiments herein describe a series of methods, each yielding potentially better quality models than the next, that include using a method of optimizing any one or combination of various aspects of a neural-network. Such aspects include, but are not limited to, Neural Architecture Search (NAS) to discover the best neural-network architecture(s); hyperparameter optimization to discover the best neural-network parameters for a network; loss function optimization to discover the best loss function(s) for a neural-network; activation function optimization to discover the best activation function(s) for a neural-network; and/or data augmentation optimization to discover the best data augmentation pipeline for a neural-network. The embodiments optimize the one or more aspects for the various combinations of models discovered and trained behind their respective firewalls with sequestered data. Exemplary optimization scenarios are described in numerous patent applications which are incorporated herein by reference.

The embodiments herein maintain data privacy, while facilitating sharing of learned attributes from each private data set (in the form of models). The data sets themselves remain private to the parties that own the data, but the models trained on the private data can be applied outside each data firewall with potential inference applications on other (potentially non-private) data.

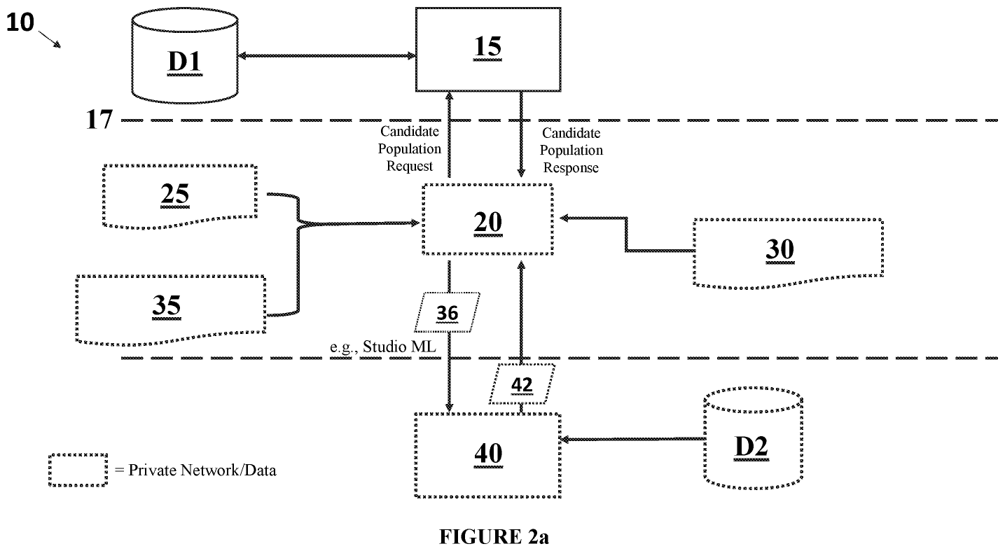

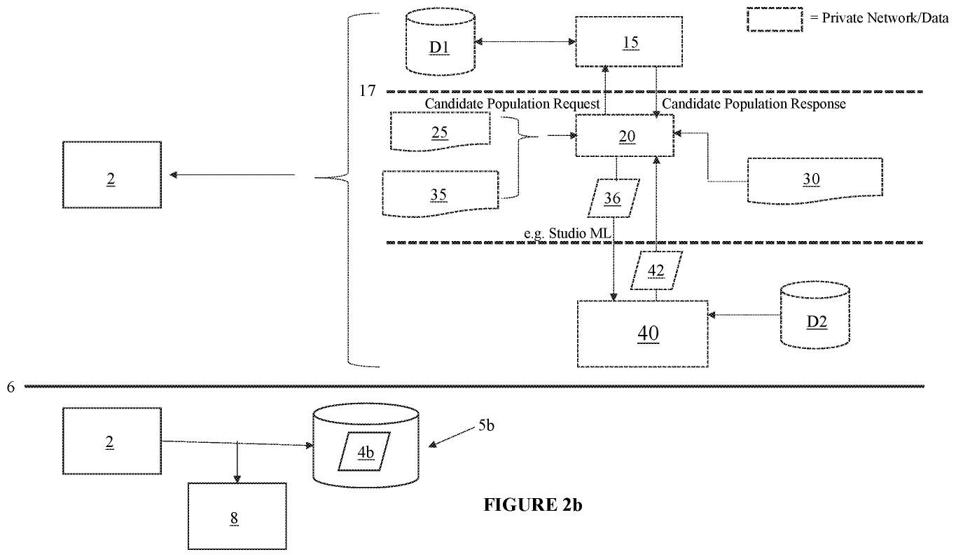

In a first embodiment, a search for an optimal teacher model (2 from FIG. 1) includes using an existing Candidate Suggestion client-service architecture, such as the exemplary Evolution as a Service (EaaS) product described in U.S. patent application Ser. No. 16/424,686, titled “SYSTEMS AND METHODS FOR PROVIDING SECURE EVOLUTION AS A SERVICE, filed May 29, 2019, which is incorporated herein by reference in its entirety. EaaS 10 includes two primary components or subsystems/processes: an evolution service (also referred to herein as a candidate suggestion service) and a candidate evaluation system. FIG. 2a illustrates an exemplary schematic of EaaS 10 components/processes including representative inputs and data flows. The evolution service subsystem (hereafter “candidate suggestion service”) 15 (an example of which is the Learning Evolutionary Algorithm Framework (LEAF) Evolutionary Neural Network (ENN) service developed and offered by the present Applicant/Assignee, Cognizant Technology Solutions US Corp.) communicates with the candidate evaluation system 20 (also called Experiment Host) across a firewall 17. Inputs to the candidate evaluation system 20 may include experiment framework code (e.g., Python) 25, experiment configuration (e.g., JSON/YAML) 30 and domain-specific evaluation code 35 (e.g., evaluate candidate( )), by way of example.

In the particular embodiment of FIG. 2a, the candidate evaluation system 20 is hosted behind the firewall 17, while the candidate suggestion service 15 is hosted in a common location. The firewall 17 may be software-driven or a conventional hardware firewall as will be appreciated by one skilled in the art.

With respect to FIG. 2a and the search for an optimal teacher model, the candidate models (i.e., population of teacher candidate models) evolved by the candidate suggestion service 15 are provided to the candidate evaluation system 20 which evaluates the teacher candidate models against the private data set(s) stored on e.g., D2. Accordingly, the candidate teacher models are all evaluated and trained on the private data set within the confines of firewall 17. Metrics measuring the performance of each candidate on the private data set are sent back to the candidate suggestion service 15 so the service can suggest a new population of candidates to try based on the previous generation of candidates. The firewall protects private data and other information from being accessible outside of the firewall 17 unless the owner/custodian of the private data and other information specifically allow access.

Further to FIG. 2a, in particular exemplary embodiment, candidate model evaluation and metric measurement may be managed by a secure framework service such as those supported by Studio.ml, in order to manage, track, reproduce, and share the candidate experiments. Studio.ml uses publicly available cloud computing resources, e.g., Amazon EC2, Google Cloud Computer, Microsoft Azure to implement Studio.ml evaluation worker instances 40. Input 36 to the Studio.ml worker instances 40 includes, e.g., an evaluation worker request with single candidate, evaluation configuration, evaluation code and Python dependencies. Output 42 from the Studio.ml worker instances 40 includes single candidate with metrics. Alternatively, for addition security, a Studio.ml worker cluster may be established privately, not in the public cloud, e.g., on-premises at a customer site, using customer dedicated resources.

After generations of candidate teacher model populations have converged upon one or more potential model solutions, at least one resulting fully-trained teacher model becomes the basis for the teacher network model 2 as shown in FIG. 2b. It is this fully trained teacher model 2 that is extracted from the firewall of the sequestered data set into a firewall (or non-firewall) area common to both teacher network model 2 and student network model 8. As shown in FIG. 2b, the extracted teacher network model 2 operates on the manufactured input data 4b from common (non-firewalled or separately firewalled) data source 5b. And the Student network model 8 learns from this operation in accordance with processes known to those skilled in the art. The manufactured (accessible) input date 4b may be augmented with some or all of the hidden data D2 if the owner wishes to release the data to the common firewall area.

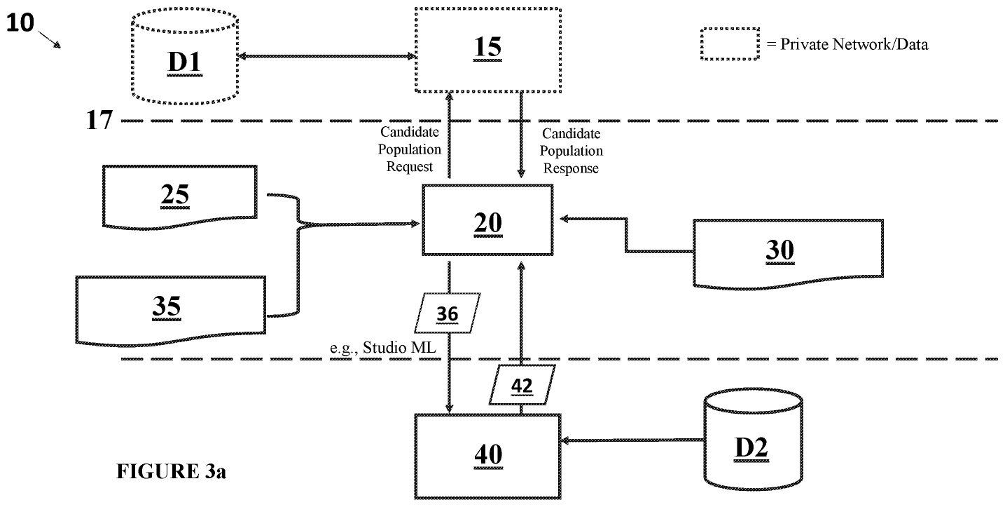

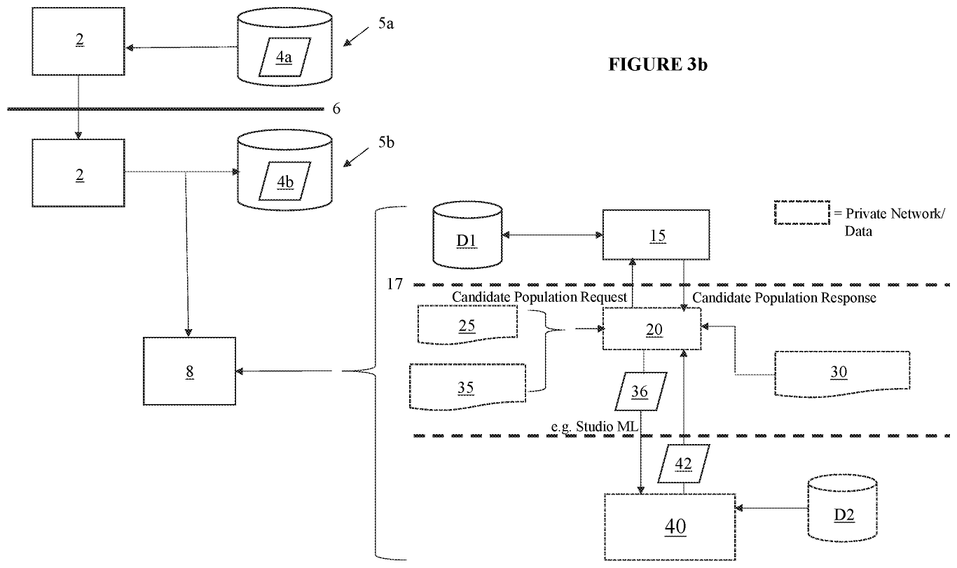

In a second exemplary embodiment, FIG. 3a, a system similar to FIG. 2a is used to discover the best student network model using the evolution service subsystem, i.e., candidate suggestion service 15, for the student network model 8 of FIG. 1. In the second exemplary embodiment, referring to FIG. 3b the teacher network model 2 is discovered using static/fixed/traditional methods of network model discovery and the private data set, but instead of training a single student network model in the common firewall area, the process instead discovers the best student network model 8 using the candidate suggestion service 15. Full training of the selected final student model 8 would proceed as shown in FIG. 3b, wherein the extracted teacher network model 2 trained on the private data 4a, operates on the manufactured input data 4b from common (non-firewalled or separately firewalled) data source 5b. And the Student network model 8 learns from this operation. The manufactured (accessible) input data 4b may be augmented with some or all of the hidden data 4a if the owner wishes to release the data to the common firewall area.

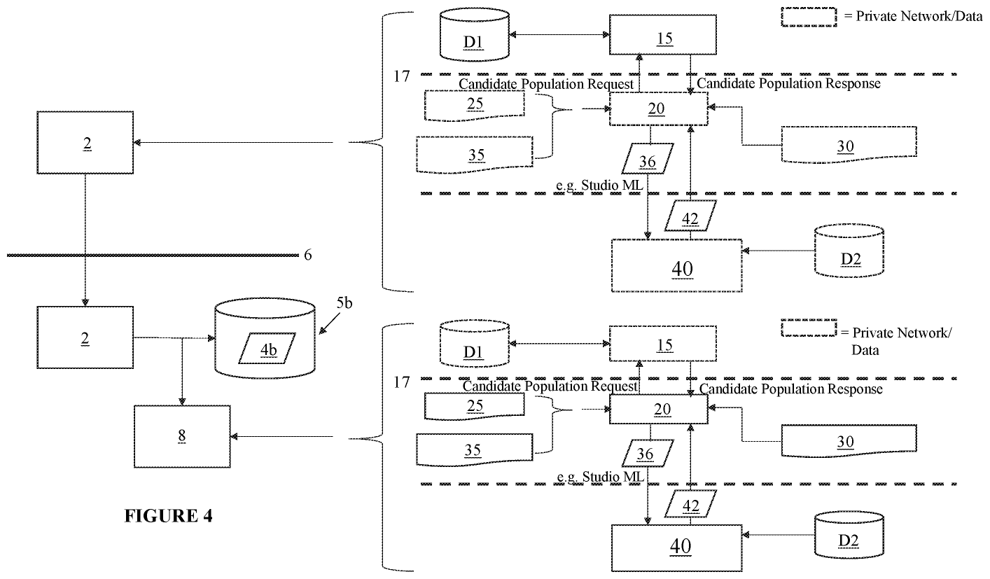

In a third exemplary embodiment, FIG. 4, elements of the embodiments described above with respect to FIGS. 2a, 2b and FIGS. 3a, 3b are combined. In FIG. 4, as described in FIG. 2, the teacher network model 2 is evolved, wherein candidate suggestion service 15 generates and provides candidate teacher models to the candidate evaluation system 20 which evaluates the candidate teacher models against the private data set(s) stored on e.g., D2. Accordingly, the candidate teacher models are all evaluated and trained on the private data set within the confines of firewall 17 on the private data set(s). Metrics measuring the performance of each candidate on the private data set are sent back to the candidate suggestion service 15 so the service can suggest a new population of candidates to try based on the previous generation of candidates. Thus a search for an optimal teacher model (2 from FIG. 1) is evolved using candidate suggestion service 15 using performance metrics generated on private data within the firewall 17.

And further to FIG. 4, the best student network model is similarly evolved using candidate suggestion service 15, for the student network model 8 of FIG. 1. Accordingly the best student network model 8 is discovered using the candidate suggestion service 15. Full training of the selected final student model 8 would proceed as described with respect to FIG. 1, wherein the extracted teacher network model 2 trained on the private data 4a, operates on the manufactured input data 4b from common (non-firewalled or separately firewalled) data source 5b. And the Student network model 8 learns from this operation.

Accordingly, an EaaS 10 is implemented on both the private and common sides of the firewall. One implementation is used to evolve and optimize the best teacher network model 2 and a second implementation is used to evolve and optimize a student network model 8 for knowledge transfer from the teacher network model 2.

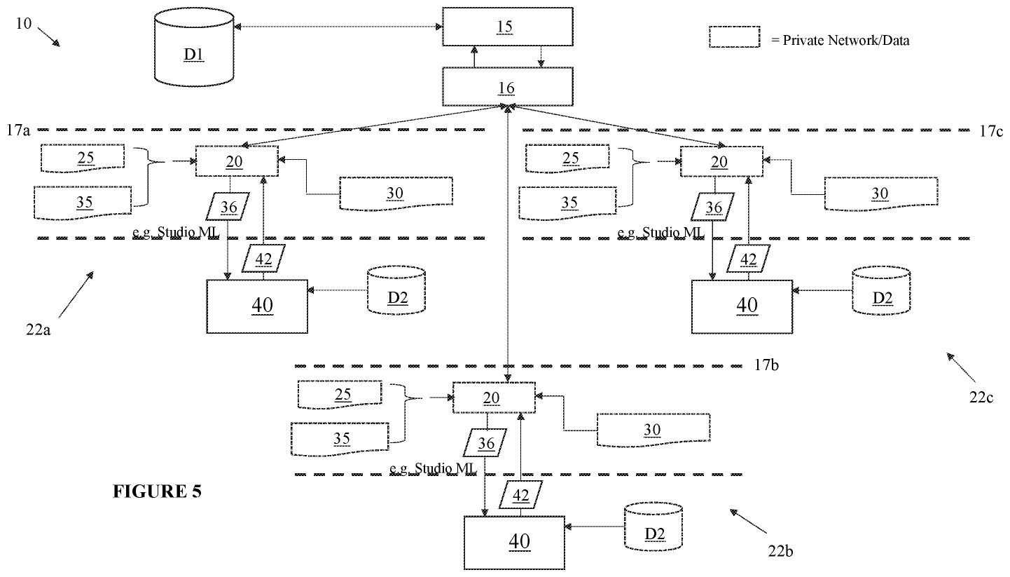

In yet another exemplary embodiment, an EaaS 10 could be used to discover the best overall model for the combined data set, i.e., accessible data set plus multiple private data sets. Referring to FIG. 5, in this embodiment, when the candidate suggestion service 15 requests evaluation of a candidate model, the request goes through a candidate evaluation aggregator 16 which facilitates evaluation of the candidate by multiple candidate evaluation clusters, e.g., 22a, 22b, 22c, each cluster being set up behind firewalls 17a, 17b, 17c and having its own private data sets.

Each candidate evaluation cluster evaluates the candidate model against its own sequestered data set, and reports metrics (not data) back to the candidate evaluation aggregator 16 for the candidate model. The candidate evaluation aggregator 16 consolidates the received metric data from however many (N) sequestered data sets/firewalls there are.

The consolidated metrics are reported back to the candidate suggestion service 15 and could be in the form of a simple mathematical aggregation of the N sequestered data sets or could be the basis for a multi-objective candidate suggestion experiment, where each objective to be maximized is the loss (or other measurement) on each data set. Full-training of the discovered architecture could then proceed as described in previous examples.

The embodiments described herein require a form of candidate model search for statistical models to discover the aspects of best models for each step. In this regard, the Assignee's existing technology, LEAF ENN, is well-suited to the distribution of responsibilities for this task. Various aspects of LEAF ENN are described in one or more of the applications incorporated herein by reference. Typical Neural Architecture Search (NAS) using LEAF ENN requires an architecture search phase which, for the candidate models referenced herein, would be required to be evaluated within each firewall to protect the private data as described herein. Additionally, NAS also requires a full-training phase once the best architecture has been discovered. This training also takes place within each firewall as needed.

As is described herein and in U.S. application Ser. No. 16/424,686, titled “SYSTEMS AND METHODS FOR PROVIDING SECURE EVOLUTION AS A SERVICE, filed May 29, 2019, the architecture search process may be separate from the candidate evaluation process. A client/server architecture where the protected algorithm that generates candidate architectures resides within a firewall may be used and accessed via web-based protocol to call into the algorithm. In these examples, the client-side may be made available to move to wherever it needs. As described, the client-side manages the evaluation of potential candidate architectures, (but not the generation of those candidates) and thus can be deployed within whichever firewall environment is available, so long as a hole is poked in that firewall such that data regarding the composition and evaluation of the candidate architectures can be sent back and forth, the data set to be kept private remains as such.

The advantage to any one of the embodiments described herein is that private data stays private for all parties, if desired by the parties, while information that can be learned from each private data set (in the form of generated and trained models) are allowed to be co-mingled with other models that are also learned from other private, public or combined data sets. The data sets themselves always stay private to the parties that own the data (subject to control by the owners of the data), but it is expected that the ‘learnings” gained from the data (in the form of generated and trained models) can be applied outside each data firewall with potential inference applications on other (potentially non-private) data.

One skilled in the art will appreciate that other kinds of statistical models could be used in these methods as well, such as rule-sets, etc. The embodiments are not limited to neural networks.

It is submitted that one skilled in the art would understand the various computing environments, including computer readable mediums, which may be used to implement the methods described herein. Selection of computing environment and individual components may be determined in accordance with memory requirements, processing requirements, security requirements and the like. It is submitted that one or more steps or combinations of step of the methods described herein may be developed locally or remotely, i.e., on a remote physical computer or virtual machine (VM). Virtual machines may be hosted on cloud-based IaaS platforms such as Amazon Web Services (AWS) and Google Cloud Platform (GCP), which are configurable in accordance memory, processing, and data storage requirements. One skilled in the art further recognizes that physical and/or virtual machines may be servers, either stand-alone or distributed. Distributed environments many include coordination software such as Spark, Hadoop, and the like. For additional description of exemplary programming languages, development software and platforms and computing environments which may be considered to implement one or more of the features, components and methods described herein, the following articles are referenced and incorporated herein by reference in their entirety: Python vs R for Artificial Intelligence, Machine Learning, and Data Science; Production vs Development Artificial Intelligence and Machine Learning; Advanced Analytics Packages, Frameworks, and Platforms by Scenario or Task by Alex Cistrons of Innoarchtech, published online by O'Reilly Media, Copyright InnoArchiTech LLC 2020.

1. A process for providing access to one or more models for use in solving a predetermined problem or making a prediction, the one or more models being trained on private data, the process comprising:
evolving a teacher model in accordance with one or more domain factors, the evolving including:
(i) creating by a first subsystem, including a first server, a first population of candidate teacher models and assigning a unique candidate identifier to each of the candidate teacher models in the first population;
(ii) transmitting the first population of candidate teacher models with assigned candidate identifiers, to a second subsystem, including a second server, wherein the first server and the second server are separated by a first firewall;
(iii) training by the second subsystem the first population of candidate teacher models against a first secure data set located behind the first firewall;
(iv) determining by the second subsystem a set of performance metrics for each of the candidate teacher models, wherein the set of performance metrics does not include secure data from the first secure data set;
(v) providing the set of performance metrics for each of the candidate teacher models in accordance with assigned candidate identifier to the first subsystem;
(vi) creating a next population of candidate teacher models from the sets of performance metrics for each of the candidate teacher models from the second subsystem;
(vii) repeating steps (ii) to (vi) until a best candidate teacher model is determined in accordance with a predetermined condition; and
providing access to the best candidate teacher model in a commonly accessible location, wherein the best candidate teacher model operates on one or more additional datasets to train one or more best candidate student models to solve the predetermined problem or make the prediction.

2. The process according to claim 1, wherein the one or more domain factors are selected from the group consisting of: domain constraints, known domain parameters and formatting rules for a specific representation of each of the candidate individuals.

3. The process according to claim 1, wherein the one or more models are neural networks.

4. The process according to claim 1, wherein the first subsystem and the commonly accessible location are separated by a second firewall.

5. The process according to claim 1, further comprising:
evolving the one or more best candidate student models in accordance with one or more domain factors, the evolving including:
(viii) creating by a third subsystem, including a third server, a first population of candidate student models and assigning a unique candidate identifier to each of the candidate student models in the first population;
(ix) transmitting the first population of candidate teacher student with assigned candidate identifiers, to a fourth subsystem, including a fourth server, wherein the third server and the fourth server are separated by a third firewall;
(x) training by the fourth subsystem the first population of candidate student models against a second secure data set located behind the third firewall;
(xi) determining by the fourth subsystem a set of performance metrics for each of the candidate student models, wherein the set of performance metrics does not include secure data from the second secure data set;
(xii) providing the set of performance metrics for each of the candidate student models in accordance with assigned candidate identifier to the third subsystem;
(xiii) creating a next population of candidate student models from the sets of performance metrics for each of the candidate student models from the fourth subsystem;
(xiv) repeating steps (ix) to (xiii) until a best candidate student model is determined in accordance with a predetermined condition; and
providing access to the best candidate student model in the commonly accessible location; and
training the best candidate student model in accordance with operation on the one or more additional datasets by the best candidate teacher model to solve the predetermined problem or make the prediction.

6. The process according to claim 5, wherein the first subsystem and the third subsystem are the same.

7. The process according to claim 1, wherein the one or more additional datasets used to train the one or more best candidate student models includes at least a portion of data from the first secure dataset.

8. A process for providing access to one or more models for use in solving a predetermined problem or making a prediction, the one or more models being trained on private data, the process comprising:
creating and training a teacher model by a first system including a first server, wherein the teacher model is trained on a first secure data set;
determining by the first system a set of performance metrics for each of the teacher model, wherein the set of performance metrics does not include secure data from the first secure data set;
providing access to the trained teacher model in a commonly accessible area, wherein the first subsystem and the commonly accessible area are separated by a first firewall;
evolving a student model in accordance with one or more domain factors, the evolving including:
(i) creating by a second subsystem, including a second server, a first population of candidate student models and assigning a unique candidate identifier to each of the candidate student models in the first population;
(ii) transmitting the first population of candidate student models with assigned candidate identifiers, to a third subsystem, including a third server, wherein the second server and the third server are separated by a second firewall;
(iii) training by the third subsystem the first population of candidate student models against a second secure data set located behind the second firewall;
(iv) determining by the third subsystem a set of performance metrics for each of the candidate student models, wherein the set of performance metrics does not include secure data from the second secure data set;
(v) providing the set of performance metrics for each of the candidate student models in accordance with assigned candidate identifier to the second subsystem;
(vi) creating a next population of candidate student models from the sets of performance metrics for each of the candidate student models from the third subsystem;
(vii) repeating steps (ii) to (vi) until a best candidate student model is determined in accordance with a predetermined condition;
providing access to the best candidate student model in the commonly accessible area, wherein the second subsystem and the commonly accessible area are separated by a third firewall; and
training the best candidate student model in accordance with operation by the trained teacher model on one or more additional datasets to solve the predetermined problem or make the prediction.

9. The process according to claim 8, wherein the one or more domain factors are selected from the group consisting of: domain constraints, known domain parameters and formatting rules for a specific representation of each of the candidate individuals.

10. The process according to claim 8, wherein the one or more models are neural networks.

11. The process according to claim 8, wherein the one or more additional datasets includes at least a portion of data from the first secure dataset.

12. A process for providing access to one or more models for use in solving a predetermined problem or making a prediction, the one or more models being trained on private data, the process comprising:
evolving a teacher model in accordance with one or more domain factors, the evolving including:
(i) creating by a first subsystem, including a first server, a first population of candidate teacher models and assigning a unique candidate identifier to each of the candidate teacher models in the first population;
(ii) transmitting the first population of candidate teacher models with assigned candidate identifiers, via a candidate evaluation aggregator of the first subsystem, to multiple individual subsystems, including multiple individual servers, wherein the candidate evaluation aggregator and each of the multiple individual subsystems are separated by multiple individual firewalls;
(iii) training by each of the multiple individual subsystems the first population of candidate teacher models against multiple individual first secure data sets located behind each of the multiple individual firewalls;
(iv) determining by each of the multiple individual subsystems a set of performance metrics for each of the candidate teacher models, wherein the sets of performance metrics do not include secure data from and of multiple individual first secure data sets;
(v) providing the sets of performance metrics for each of the candidate teacher models in accordance with assigned candidate identifier to the candidate evaluation aggregator;
(vi) creating a next population of candidate teacher models from the sets of performance metrics for each of the candidate teacher models from each of the multiple individual subsystems;
(vii) repeating steps (ii) to (vi) until a best candidate teacher model is determined in accordance with a predetermined condition; and
providing access to the best candidate teacher model in a commonly accessible location, wherein the best candidate teacher model operates on one or more additional datasets to train one or more best candidate student models to solve the predetermined problem or make the prediction.

13. The process according to claim 12, wherein the one or more domain factors are selected from the group consisting of: domain constraints, known domain parameters and formatting rules for a specific representation of each of the candidate individuals.

14. The process according to claim 12, wherein the one or more models are neural networks.

15. The process according to claim 12, wherein the first subsystem and the commonly accessible location are separated by a second firewall.

16. The process according to claim 12, further comprising:
evolving the one or more best candidate student models in accordance with one or more domain factors, the evolving including:
(viii) creating by a second subsystem, including a second server, a first population of candidate student models and assigning a unique candidate identifier to each of the candidate student models in the first population;
(ix) transmitting the first population of candidate teacher student with assigned candidate identifiers, to a third subsystem, including a third server, wherein the second server and the third server are separated by a third firewall;
(x) training by the third subsystem the first population of candidate student models against a second secure data set located behind the third firewall;
(xi) determining by the third subsystem a set of performance metrics for each of the candidate student models, wherein the set of performance metrics does not include secure data from the second secure data set;
(xii) providing the set of performance metrics for each of the candidate student models in accordance with assigned candidate identifier to the second subsystem;
(xiii) creating a next population of candidate student models from the sets of performance metrics for each of the candidate student models from the third subsystem;
(xiv) repeating steps (ix) to (xiii) until a best candidate student model is determined in accordance with a predetermined condition; and
providing access to the best candidate student model in the commonly accessible location; and
training the best candidate student model in accordance with operation on the one or more additional datasets by the best candidate teacher model to solve the predetermined problem or make the prediction.

17. The process according to claim 16, wherein the first subsystem and the second subsystem are the same.

18. The process according to claim 1, wherein the one or more additional datasets used to train the one or more best candidate student models includes at least a portion of data from one or more of the multiple individual first secure datasets.
